(19) United States
(12) Patent Application Publication
(10) Pub. No.: US 2024/0159518 A1
(43) Pub. Date: May 16, 2024

(54) UNEVENLY DISTRIBUTED ILLUMINATION FOR DEPTH SENSOR

(71) Applicant: Innovusion, Inc., Sunnyvale, CA (US)

(72) Inventor: Haosen Wang, Sunnyvale, CA (US)

(73) Assignee: Innovusion, Inc., Sunnyvale, CA (US)

(21) Appl. No.: 18/389,406

(22) Filed: Nov. 14, 2023

Related U.S. Application Data
(60) Provisional application No. 63/425,644, filed on Nov. 15, 2022.

(51) Int. Cl. G01B 11/22; G01S 7/481; G01S 17/931

(52) U.S. Cl. CPC G01B 11/22; G01S 7/4815; G01S 7/4817; G01S 17/931

(57) ABSTRACT

A depth sensor is provided. The depth sensor comprises one or more light sources configured to provide a plurality of light beams; and one or more optical structures coupled to the one or more light sources. The one or more optical structures are configured to receive the plurality of light beams. At least one of the one or more light sources or the one or more optical structures are configured to unevenly distribute the plurality of light beams in a vertical field-of-view (FOV) such that the vertical FOV comprises a dense area and a sparse area. The dense area of the vertical FOV has a higher beam density than the sparse area of the vertical FOV, and the depth sensor comprises no mechanically movable parts configured to scan light.

### CROSS-REFERENCE TO RELATED APPLICATIONS

This application claims priority to U.S. Provisional Patent Application Ser. No. 63/425,644, filed Nov. 15, 2022, entitled “UNEVENLY DISTRIBUTED ILLUMINATION FOR DEPTH SENSOR,” the content of which is hereby incorporated by reference in its entirety for all purposes.

### FIELD OF THE TECHNOLOGY

This disclosure relates generally to a depth sensor and, more particularly, to unevenly distributed illumination for a depth sensor.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminates an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

A depth sensor, also referred to as a depth camera or 3D sensor, is a device that can capture the spatial information of objects in its field of view. These sensors are designed to measure the distance from the sensor to various points in the environment, creating a three-dimensional representation of the scene. A depth sensor may use a direct time-of-flight (dToF) method to measure the distance (also referred to as the depth) and thus is a dToF sensor. A depth sensor may also be an indirect time-of-flight (iToF) sensor, which uses an indirect time-of-flight (iToF) method to measure the distance. A solid-state depth sensor is a type of depth sensor that can output three-dimensional (3D) depth measurement results of an external environment while having no mechanically moving parts inside the sensor. It can be, for example, a flash LiDAR, which may use a vertical cavity surface emitting laser (VCSEL) as a light source and single-photon avalanche diode (SPAD) arrays as light detectors. Having no mechanically moving part is an advantage of the solid-state depth sensor. When a solid-state depth sensor operates, a laser source emits laser light to the field-of-view and a light detector captures the reflected or scattered light (also referred to as the return light) from the object. In the following disclosure, the depth sensor, flash LiDAR, iToF sensor may also be referred to as LiDAR. The flash LiDAR is also referred to as a dToF sensor. The disclosure therefore uses LiDAR as an example of a depth sensor. However, it is understood that a depth sensor can be a ToF sensor, a structured light sensor (e.g., using a known pattern of light to measure the depth based on light distortion), a stereo vision sensor (e.g., using two or more cameras to measure depth), or LiDAR systems. This disclosure provides a novel method to optimize the emitting light distribution of the solid-state depth sensor. With this novel method, the detection range distribution of the depth sensor can be optimized, and energy consumption can be reduced.

In one embodiment, a depth sensor is provided. The depth sensor comprises one or more light sources configured to provide a plurality of light beams; and one or more optical structures coupled to the one or more light sources. The one or more optical structures are configured to receive the plurality of light beams. At least one of the one or more light sources or the one or more optical structures are configured to unevenly distribute the plurality of light beams in a vertical field-of-view (FOV) such that the vertical FOV comprises a dense area and a sparse area. The dense area of the vertical FOV has a higher beam density than the sparse area of the vertical FOV, and the depth sensor comprises no mechanically movable parts configured to scan light.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example semiconductor-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an example depth sensor, according to some embodiments.

FIG. 8 is a block diagram illustrating another example depth sensor, according to some embodiments.

FIG. 9 illustrates an example depth sensor providing unevenly distributed light beams in a vertical direction of an FOV, according to some embodiments.

FIG. 10 is a block diagram illustrating the variation of the detection range requirements according to the transmission light angles in the vertical FOV, according to some embodiments.

FIG. 11 is a block diagram illustrating providing uneven distribution of light beams by unevenly placing VCSEL elements in a VCSEL laser array, according to some embodiments.

FIG. 12 is a block diagram illustrating providing uneven distribution of light beams by using an optical diffuser, according to some embodiments.

FIG. 13 is a block diagram illustrating providing uneven distribution of light beams by using a semiconductor wafer having a micro-lens array, according to some embodiments.

FIG. 14 is a flowchart illustrating a method for unevenly distributing a plurality of light beams using a depth sensor, according to some embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first detection range could be termed a second detection range and, similarly, a second detection range could be termed a first detection range, without departing from the scope of the various described examples. The first detection range and the second detection range can both be detection ranges and, in some cases, can be separate and different detection ranges.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

A solid-state depth sensor is a sensor that can output three-dimensional (3D) depth measurement results of a field-of-view while having no mechanically movable parts inside the sensor. Solid-state depth sensors can be semiconductor-based sensors. One type of solid-state sensor is a flash LiDAR. When a flash LiDAR operates, the entire FOV is typically illuminated with a wide diverging laser beam in a single pulse or single shot. Unlike scanning LiDAR (e.g., a LiDAR system having an optical steering mechanism), a flash LiDAR may not have mechanically movable optics for scanning the FOV. Therefore, without using a scanning component, a flash LiDAR may be more compact than a scanning LiDAR. Eliminating the mechanically movable parts also makes a flash LiDAR (and other solid-state depth sensors) more robust, durable, and reliable.

A solid-state depth sensor may use a vertical cavity surface emitting laser (VCSEL) as a light source. A VCSEL is a type of semiconductor laser diode with laser beam emission perpendicular to the wafer surface or a mounting surface. In contrast, an edge-emitting semiconductor laser (EEL) propagates the laser light in a direction along, or parallel to, the wafer surface of the semiconductor chip. For an edge-emitting semiconductor laser, the laser light is usually reflected or coupled out at the cleaved edge of the wafer. Compared to EELs, VCSELs may offer a higher beam quality and thus better performance. VCSELs tend to have lower power lasers compared to EELs. In addition, testing of VCSELs is usually easier than testing EELs. For example, the testing of VCSELs can use wafer probe machines with lower costs and simpler procedures, which are readily available in the semiconductor industry.

A solid-state depth sensor may use single-photon avalanche diode (SPAD) arrays as light detectors for detecting return light. As described above, return light is the light formed in the FOV when the transmission light beams from a depth sensor are scattered or reflected by one or more objects in the FOV. A single-photon avalanche diode or SPAD is a solid-state photodetector based on a reverse biased semiconductor p-n junction like photodiodes and avalanche photodiodes (APDs). Unlike regular photodiodes, a SPAD operates in a mode referred to as the “Geiger mode” where a single incoming photon can create an electron-hole pair which is amplified enough to create a measurable current. Therefore, SPADs are intrinsically able to detect single-photons, with a very high temporal resolution. A key component of a SPAD is a region within the diode called the depletion region. This region is designed to have a high electric field, which allows it to function as a high-gain avalanche photodiode. When a single photon interacts with the depletion region, it generates an electron-hole pair. The high electric field across the depletion region causes the electron and hole to accelerate, leading to a process known as impact ionization in which each electron or hole can gain enough energy to generate another electron-hole pair, resulting in an avalanche effect. This avalanche process rapidly amplifies the initial signal, converting the weak optical signal from the single photon into a detectable electrical pulse. Multiple SPADs can be arranged to form 1-dimensional arrays, 2-dimensional arrays, or 3-dimensional arrays.

Other than the light source and the light detector, a depth sensor may have other components such as optics and control circuitry, which are described in more details below. A depth sensor may use a direct time of flight (dToF) method to measure the distance (also referred to as the depth) and thus is a dToF sensor. A depth sensor may also be an indirect time-of-flight (iToF) sensor, which uses an indirect time of flight (iToF) method to measure distance. The dToF method involves a direct measurement of the time of flight between the time when light is emitted from the depth sensor and the time when return light is detected by the depth sensor. Using the time of flight, the distance between the depth sensor and the target object can be computed (with the well-known speed of light). The iToF method measures the distance by collecting the return light and discerning the phase shift between emitted light and the return light. The iToF method is especially effective in high-speed, high-resolution 3D imaging of objects at short and long distances. Indirect ToF sensors send out continuous, modulated light and measure the phase of the return light to calculate the distance to a target object.

As described above, a solid-state depth sensor may not have any mechanically movable parts. Having no movable part is an advantage of the solid-state depth sensor. When a solid-state depth sensor operates, a laser source (e.g., a VCSEL) emits laser light to the FOV and the detector (e.g., a SPAD array) captures the return light form by the object in the FOV. In this disclosure, the depth sensor, flash LiDAR, iToF sensor, and the dToF sensor may also be referred to as LiDAR. The disclosure therefore uses LiDAR as an example and may use LiDAR and depth sensor interchangeably. This disclosure provides a novel method to optimize the emitting light distribution of the solid-state depth sensor. With this novel method, the detection range distribution of the depth sensor can be optimized. Energy consumption of the depth sensor can also be reduced.

In one embodiment, a depth sensor is provided. The depth sensor comprises one or more light sources configured to provide a plurality of light beams; and one or more optical structures coupled to the one or more light sources. The one or more optical structures are configured to receive the plurality of light beams. At least one of the one or more light sources or the one or more optical structures are configured to unevenly distribute the plurality of light beams in a vertical field-of-view (FOV) such that the vertical FOV comprises a dense area and a sparse area. The dense area of the vertical FOV has a higher beam density than the sparse area of the vertical FOV, and the depth sensor comprises no mechanically movable parts configured to scan light to the FOV.

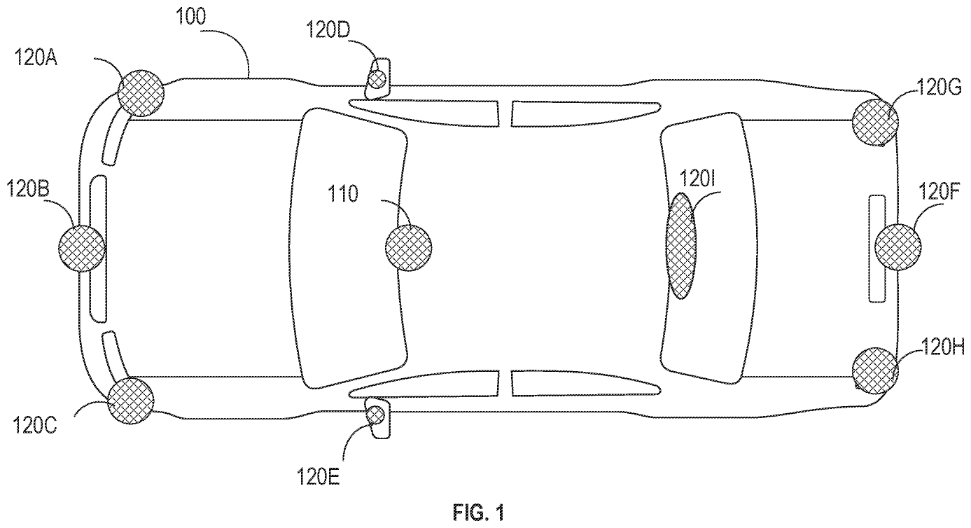

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

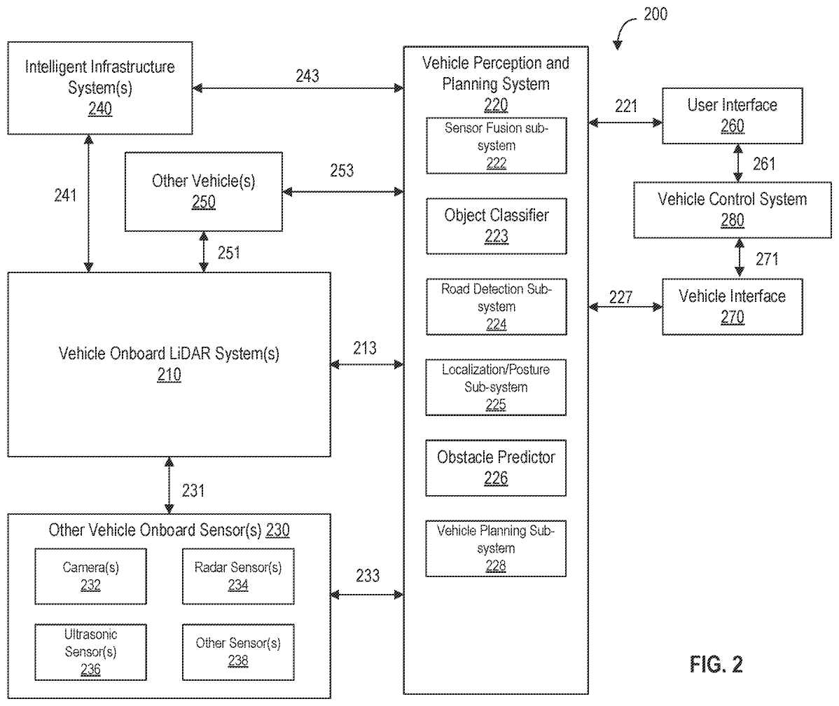

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

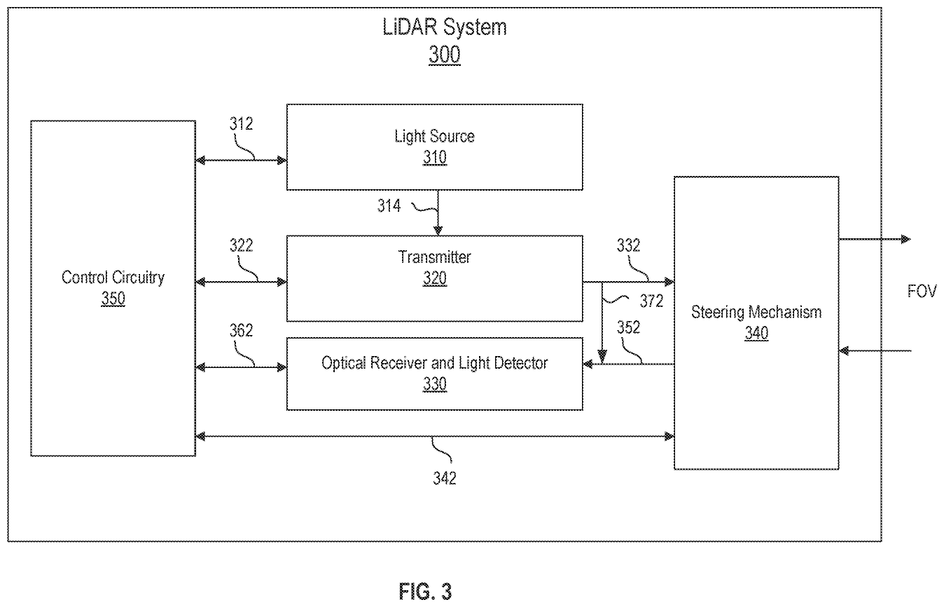

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YV04) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

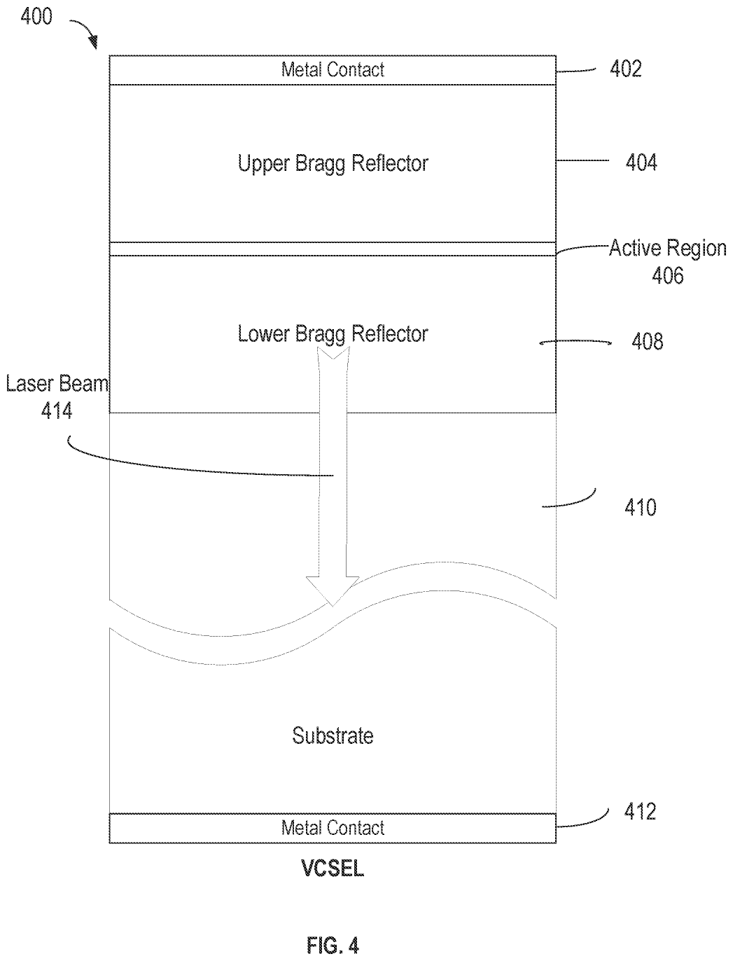

FIG. 4 is a block diagram illustrating an example semiconductor-based laser source 400. Semiconductor-based laser source 400 is an example of light source 310 depicted in FIG. 3. In the example shown in FIG. 4, laser source 400 is a Vertical-Cavity Surface-Emitting Laser (VCSEL), which is a type of semiconductor laser diode with a distinctive structure that allows it to emit light vertically from the surface of the chip, rather than through the edge of the chip like the edge-emitting laser (EEL) diodes. VCSELs have advantages like high-speed operation and easy integration into semiconductor devices. FIG. 4 shows a cross-sectional view of an example VCSEL 400. In this example, the VCSEL 400 includes a metal contact layer 402, an upper Bragg reflector 404, an active region 406, a lower Bragg reflector 408, a substrate 410, and another metal contact 412. In the VCSEL 400, the metal contacts 402 and 412 are for making electrical contacts so that electrical current and/or voltage can be provided to VCSEL 400 for generating laser light. The substrate layer 410 is a semiconductor substrate, which can be, for example, a gallium arsenide (GaAs) substrate. VCSEL 400 uses a laser resonator, which includes two distributed Bragg reflector (DBR) reflectors (i.e., upper Bragg reflector 404 and lower Bragg reflector 408) with an active region 406 sandwiched between the DBR reflectors. The active region 406 includes, for example, one or more quantum wells for the laser light generation. The planar DBR-reflectors can be mirrors having layers with alternating high and low refractive indices. Each layer has a thickness of a quarter of the laser wavelength in the material, yielding intensity reflectivities above e.g., 99%. High reflectivity mirrors in VCSELs can balance the short axial length of the gain region. In one example of VCSEL 400, the upper and lower DBR reflectors 404 and 408 can be doped as p-type and n-type materials, forming a diode junction. In another example, the p-type and n-type regions may be embedded between the reflectors, requiring a more complex semiconductor process to make electrical contact to the active region, but eliminating electrical power loss in the DBR structure. The active region 406 is sandwiched between the DBR reflectors 404 and 408 of the VCSEL 400. The active region is where the laser light generation occurs. The active region 406 typically has a quantum well or quantum dot structure, which contains the gain medium responsible for light amplification. When an electric current is applied to the active region 406, it generates photons by stimulated emission. The distance between the upper and lower DBR reflectors 404 and 408 defines the cavity length of the VCSEL 400. The cavity length in turn determines the wavelength of the emitted light and influences the laser's performance characteristics. When an electrical current is applied to the VCSEL, it generates light that bounces between the DBR reflectors 404 and 408 and exits the VCSEL 400 through, for example, the lower DBR reflector 408, producing a highly coherent and vertically emitted laser beam 414. VCSEL 400 can provide an improved beam quality, low threshold current, and the ability to produce single-mode or multi-mode output.

In some variations, VCSEL 400 can be controlled (e.g., by control circuitry 350) to produce pulses of different amplitudes. Communication path 312 couples VCSEL 400 to control circuitry 350 (shown in FIG. 3) so that components of VCSEL 400 can be controlled by or otherwise communicate with control circuitry 350. Alternatively, VCSEL 400 may include its own dedicated controller. Instead of control circuitry 350 communicating directly with components of VCSEL 400, a dedicated controller of VCSEL 400 communicates with control circuitry 350 and controls and/or communicates with the components of VCSEL 400. VCSEL 400 can also include other components not shown, such as one or more power connectors, power supplies, and/or power lines.

VCSEL 400 can be used to generate laser pulses or continuous wave (CW) lasers. To generate laser pulses, control circuitry 350 modulates the current supplied to the VCSEL 400. By rapidly turning the supply current on and off, pulses of laser light can be generated. The duration, repetition rate, and shape of the pulses can be controlled by adjusting the modulation parameters. As another example, VCSEL 400 can also be a mode-locked VCSEL that uses a combination of current modulation and optical feedback to obtain ultra-short pulses. The mode-locked VCSEL may also be controlled to synchronize the phases of the laser modes to produce very short and high-intensity pulses. As another example, VCSEL 400 can use Q-Switching techniques, which includes an optical switch in the laser cavity, temporarily blocking the lasing action and allows energy to build up in the cavity. When the switch is opened, a high-intensity pulse is emitted. As another example, VCSEL 400 can also have external modulation performed by an external modulator, such as an electro-optic or acousto-optic modulator. The external modulation can be used in combination with the VCSEL itself to create pulsed output. The external modulator can be used to control the pulse duration and repetition rate. The type of VCSEL used as at least a part of light source 310 depends on the application and the required pulse characteristics, such as pulse duration, repetition rate, and peak power. Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M 2 factor) is used for measurement of laser beam quality. In many LiDAR applications, it is important to have good laser beam quality in the generated transmitting laser beam. The M 2 factor represents a degree of variation of a beam from an ideal Gaussian beam. Thus, the M 2 factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M 2 factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

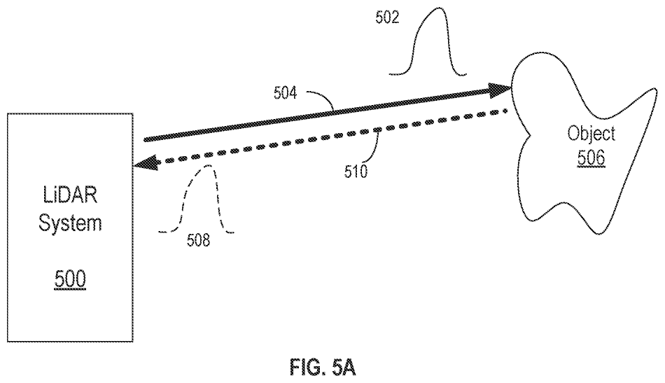

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

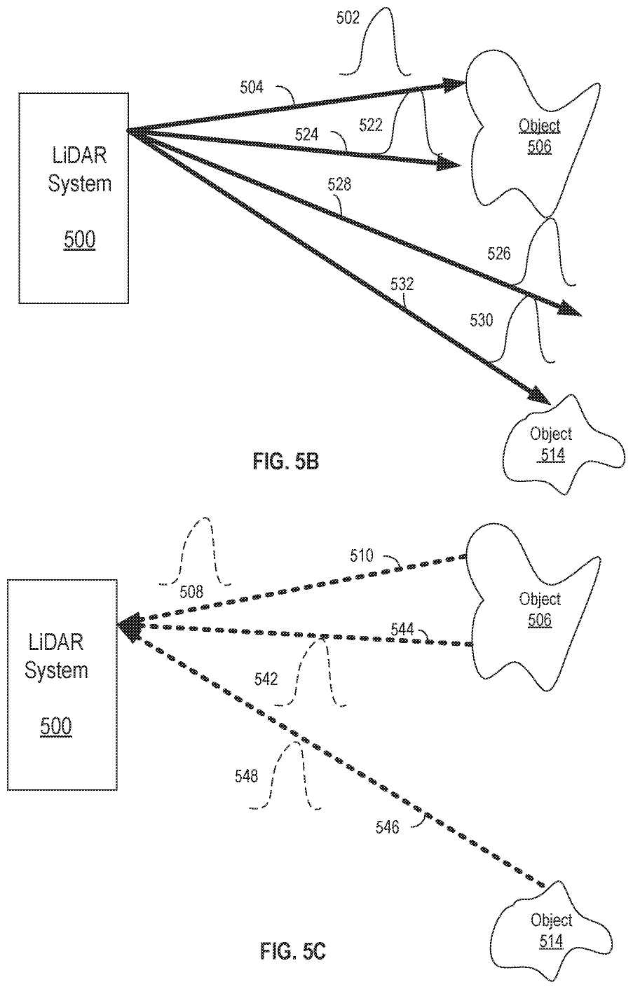

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-13. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

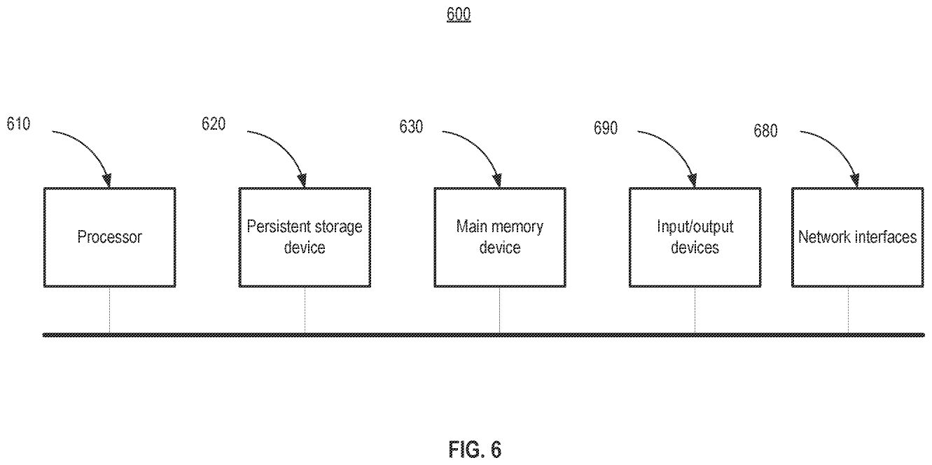

FIG. 7 is a block diagram illustrating an example depth sensor 700, according to some embodiments. Depth sensor 700 includes light source(s) 710, transmitter 720, optical receiver and light detector 730, and control circuitry 750. These components may be the substantially the same as or similar to light source 310, transmitter 320, optical receiver and light detector 330, and control circuitry 350, respectively, as described above with respect to FIG. 3. In FIG. 7, the communication paths 712, 722, 732, 752, 762, and 772 can also be substantially the same as or similar to paths 312, 322, 332, 352, 362, and 372, respectively described above, and are thus not repeatedly described.

In one embodiment, light source(s) 710 may include a semiconductor-based laser source (e.g., VCSEL), a fiber-based laser source (e.g., a rare-earth doped fiber for emitting laser light), a liquid-based laser source (e.g., dye lasers such as sodium fluorescein, rhodamine B and rhodamine 6G), a solid-state based laser source (e.g., lasers using neodymium crystals, usually doped with either yttrium aluminum garnet (Nd:YAG), yttrium orthovanadate (Nd:YVO₄), or yttrium lithium fluoride (Nd:YLF)), and/or a gas based laser source (e.g., carbon dioxide or CO₂, argon, or helium-neon based lasers). In the examples described below, the VCSEL is used for illustration. But it is understood that other types of laser sources can also be used.

Optical receiver and light detector 730 may include any types of light detectors such as photodiodes, avalanche photodiodes (APDs), SPADs, phototransistors, charge-coupled devices (CCDs), CMOS image sensors (CIS), and/or photomultiplier tubes (PMTs). In the examples described below, a high sensitivity light detector or detectors like an SPAD array is used as an example for illustration.

Compared to LiDAR system 300, depth sensor 700 has no steering mechanism or any other mechanically movable scanning optics. Thus, depth sensor 700 eliminates any mechanically movable parts configured to scan light. Depth sensor 700 can thus be more compact, robust, durable, and reliable. In one example, depth sensor 700 is a flash LiDAR that emits laser light to illuminate the entire FOV in a single pulse or single shot. Depth sensor 700 can be a solid state LiDAR device configured to perform electronic scanning. Compared to optical scanning, electronic scanning does not use mechanically movable optics to scan light. Instead, the solid state LiDAR device may use phase based scanning that emits a constant laser beam into multiple phases. It then compares the phase shifts of the returned laser energy. The laser scanner uses phase-shift algorithms to determine the distance, based on the unique properties of each individual phase based on this following formula: (Time of Flight=Phase Shift/(2π×Modulation Frequency). Phase-based scanners can collect data at a much faster speed than time-of-flight scanners that use mechanical scanning, but their effective detection range may be shorter. Additionally, phase-based scanners may sometimes have more “noise,” or false data, than time-of-flight scanners. For electronic scanning, in one example, it contains a matrix of light sources and detectors. Each light source has its own column and row index. The firing sequence of the light matrix can be programmed and controlled. Each detector can collect the return light from the object. The light source and detector match each other optically. Each detector calculates the time of flight on its own. Then a depth image can be created.

In some embodiments, depth sensor 700 can be a flash LiDAR. As described above, when a flash LiDAR operates, the entire field of view is illuminated with a wide diverging laser beam in a single pulse. In a scanning LiDAR (e.g., LiDAR system 300 shown in FIG. 3), a collimated laser beam scanned by steering mechanism 340 illuminates a single point in the FOV at a time, and the beam is raster scanned to illuminate the FOV point-by-point and line-by-line. The flash LiDAR illumination method requires a different detection scheme compared to the scanning LiDAR illumination method. In both the scanning and flash LiDAR systems, a light detector and a time-of-flight engine are used to collect and process data related to both the 3-D location and intensity of the return light incident on the light detector in every frame. In scanning LiDAR, the light detector may contain a point sensor, while in flash LiDAR, the light detector contains either a 1-D or a 2-D sensor array, each pixel of which collects 3-D location and intensity information. In both cases, the depth information is computed using the time-of-flight engine based on the transmitted laser pulse and the return light (i.e., the time it takes each laser pulse to hit the target object and return to the sensor). The result is a point cloud including distance information of the target object. A flash LiDAR can be especially advantageous, when compared to scanning LiDAR, when the sensor, the FOV, or both are moving, since the entire FOV is illuminated at the same time.

In some embodiments, depth sensor 700 can be an iToF sensor that uses an iToF method to measure the distance of a target object. The iToF method measures the distance by collecting the return light and discerning the phase shift between emitted light and the return light. The iToF method is especially effective in high-speed, high-resolution 3D imaging of objects at short and long distances. Indirect ToF based depth sensors send out continuous, modulated light and measure the phase of the return light to calculate the distance to a target object.

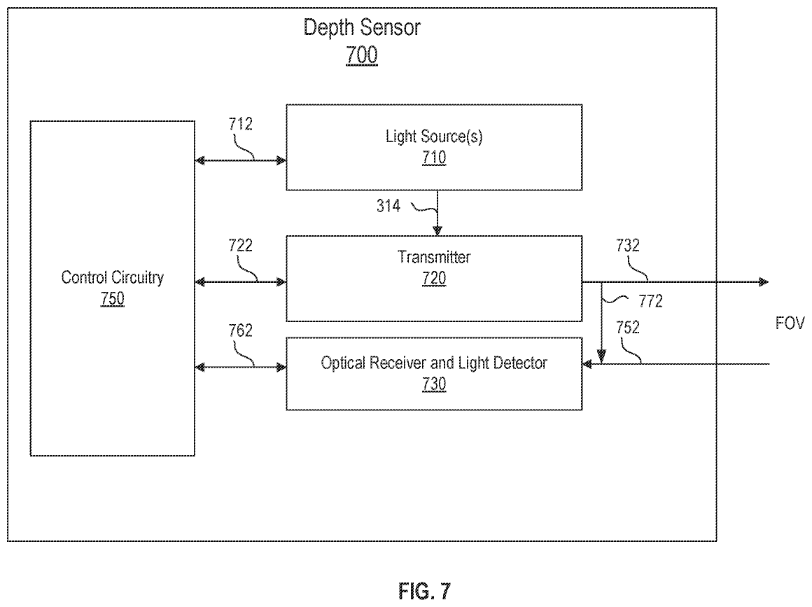

As shown in FIG. 7, in some embodiments, light source(s) 710 emit light beams to the transmitter 720, which provides the light to illuminate an FOV. Transmitter 720 may include one or more optical structures configured to distribute the light beams to the FOV. In some embodiments, light source(s) 710 can directly illuminate the FOV and thus depth sensor 700 may not include a transmitter 720. FIG. 8 is a block diagram illustrating an example depth sensor 800, according to some embodiments. Depth sensor 800 can be used to implement depth sensor 700 shown in FIG. 7. With reference to FIG. 8, in this example, depth sensor 800 includes a VCSEL laser array 810 as the light source, an SPAD array 830 as one or more light detector(s), a time-of-flight engine 850, emitting optics 820, and receiving optics 840. For simplicity, other components are omitted from FIG. 8. It is understood that the VCSEL laser array 810 and SPAD array 830 are for illustration purposes and other types of light sources and detectors can be used in depth sensor 800.

As shown in FIG. 8, in one embodiment, an VCSEL laser array 810 emits laser light beams 832 to emitting optics 820, which may include one or more of a lens, a lens group, a mirror, a prism, micro lenses, diffusers, or any other optics. Emitting optics 820 may include optical structures configured to receive light beams emitted from the VCSEL laser array 810 and transmit the light beams to an FOV as transmission light beams 832. Emitting optics 820 can be a part of transmitter 720 shown in FIG. 7. Examples of the optical structures are described below in more detail. In one example, receiving optics 840 may include a collection lens or a lens group, optical fibers or fiber arrays, optical filters, one or more converging lenses, one or more optical splitters or other light separation devices, or a combination thereof for collecting and directing return light 852 to SPAD array 830 in depth sensor 800. SPAD array 830, as described above, can include highly sensitive light detectors configured to convert detected photons in return light 852 to electrical signals. The electrical signals can be provided to a time-of-flight engine 850 for processing. For example, the time-of-flight engine 850 can compute the distance of target object 870 using the time and/or phase information associated with the return light 852 and a time and/or phase associated with the transmission light beams 832 (or a reference light beam). The time-of-flight engine 850 can be part of control circuitry 750 (or control circuitry 350) described above. It can include one or more processors and program for computing the distance of the target object 870 based on the dToF method and/or the iToF method described above. In one embodiment, the depth sensor 800 is a flash LiDAR or an iToF sensor.

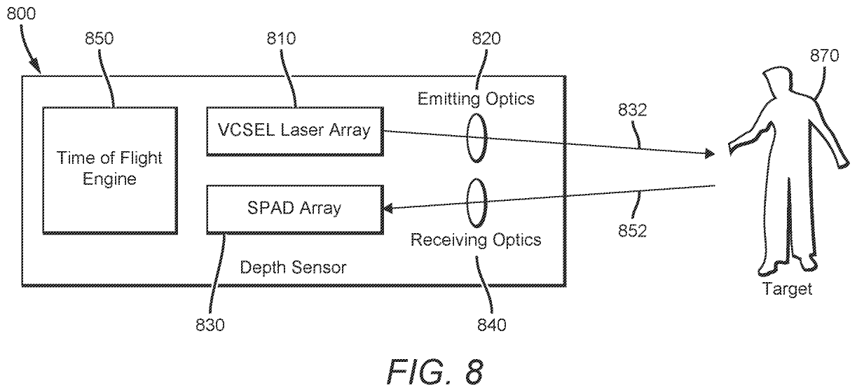

FIG. 9 illustrates an example depth sensor 900 providing unevenly distributed light beams in a vertical direction of an FOV, according to some embodiments. In one example, depth sensor 900 can include light source(s) 902, optical structure(s) 904, and receiver 906. Light source(s) 902 can the substantially the same or similar to light source(s) 710 or VCSEL laser array 810. The optical structure(s) 904 can include optical components such as one or more optical diffusers, a micro-lens array, and/or other optical components (e.g., lenses, mirrors, prisms, etc.). The optical structure(s) 904 can be used to form emitting optics 820 described above and are described in more detail below. Receiver 906 can include receiving optics (e.g., substantially the same or similar to receiving optics 840) and light detector(s) (e.g., SPAD arrays). Receiver 906 is configured to receive and detect return light formed by scattering or reflecting the transmission light beams by objects in the FOV.

As shown in FIG. 9, at least one of the one or more light sources 902 or the one or more optical structures 904 are configured to unevenly distribute a plurality of light beams in a vertical field-of-view (FOV) such that the vertical FOV comprises a dense area and a sparse area. The dense area of the vertical FOV has a higher beam density than the sparse area of the vertical FOV. For example, FIG. 9 illustrates that the light beams provided by light source(s) 902 and/or optical structure(s) 904 include beams 932 and 942. Light beams 932 are more densely distributed than the light beams 942. Light beams 932 are used to illuminate and detect objects located in the front direction within a vertical angle range of, for example, about −5 degrees to 0 degrees, or −5 degrees to +5 degrees. One such object 970 is shown in FIG. 9. Light beams 942 are used to illuminate and detect objects located in the front direction within a vertical angle range of, for example, at least one of −90 degrees to −5 degrees, or +5 degrees to +90 degrees. The sparse area shown in FIG. 9 is a part of the area covered by light beams 942. For example, FIG. 9 does not show the complete −90 degrees to −5 degrees vertical angle range and the +5 degrees to +90 degrees range, which are also a part of the sparse areas. The vertical FOV covered by both light beams 932 and light beams 942 can thus be from −90 degrees to +90 degrees.

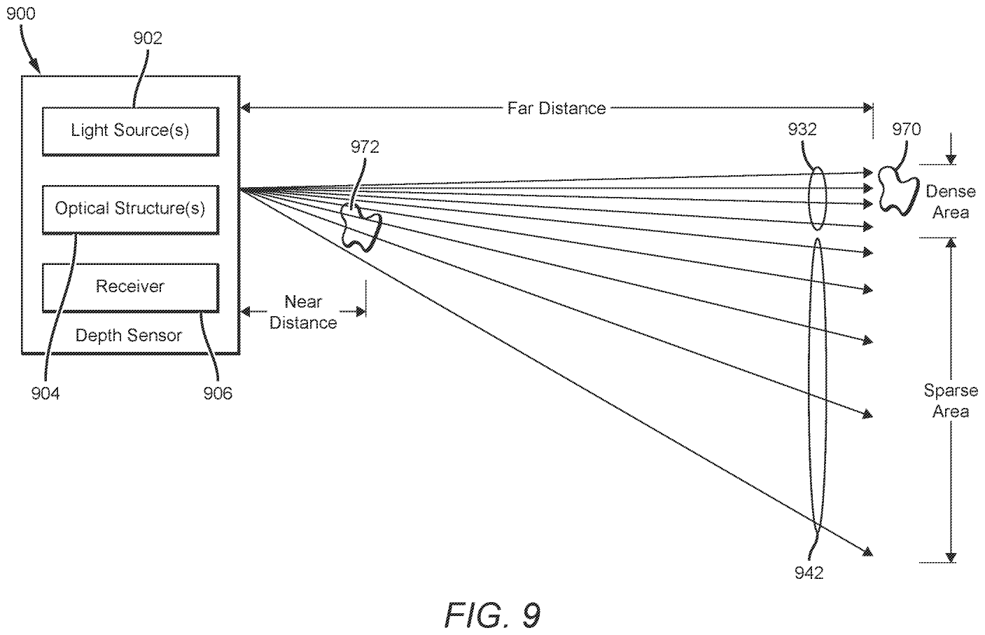

As illustrated by FIG. 9, in at least a part of the vertical angle range of the FOV, the light beams are unevenly distributed. Within the dense area (e.g., −5 degrees to 0 degrees, or −5 degrees to +5 degrees), the light beams are dense. Within the sparse area (e.g., −90 degrees to −5 degrees, or +5 degrees to +90 degrees), the light beams are sparse or less dense than those in the dense area. The uneven distribution of the light beams optimizes the light distribution and the detection of objects in different detection ranges with satisfactory resolution. The optimization of the detection range with the uneven light distribution is described in further detail using FIG. 10.

FIG. 10 is a block diagram illustrating variations of the range detection requirements according to the transmission light angles in the vertical FOV, according to some embodiments. As shown in FIG. 10, two example depth sensors 1000A and 1000B are mounted to a vehicle 1090. Depth sensors 1000A or 1000B can be implemented using any one of depth sensors 700, 800, and 900 described above. FIG. 10 uses depth sensor 1000B as an illustration for the range detection requirement. Depth sensor 1000B is mounted to vehicle 1090 at a height of about, for example, 0.84-1.1 m above the road surface 1002. As shown in FIG. 10, if a light beam is transmitted at 0 degrees (or within about −5 degrees to +5 degrees) vertical angle, the detection range of this light beam can reach a far distance, e.g., 50 m to 150 m. Such a zero-degree vertical angle light beam travels in a direction that is substantially parallel to the road surface 1002. A vertical angle of a light beam emitted by a depth sensor refers to the angle of the beam in the vertical direction (e.g., the angle between the light beam and a line parallel to the road surface or a mounting surface of the depth sensor). The vertical direction is typically perpendicular to the road surface 1002, and the horizontal direction is typically parallel to the road surface 1002.

As further illustrated in FIG. 10, if a light beam is transmitted at −5 degrees vertical angle, the detection range of the light beam is significantly reduced to about 11.4 m in the horizontal direction before the light beam reaches the road surface. Similarly, if the light beam is transmitted at −15 degrees, −30 degrees, −45 degrees, and −60 degrees, the detection ranges are further reduced to 3.9 m, 2 m, 1.4 m, and 1.2 m (equivalent to 3.7 m, 1.7 m, 1.0 m, and 0.6 m in the horizontal direction), respectively, before the light beam reaches the road surface 1002. As can be seen from FIG. 10, the detection range of the depth sensor 1000B in the horizontal direction quickly becomes shorter as the vertical angle of light beam emitted by depth sensor 1000B becomes larger (in the negative vertical direction). In other words, as the vertical angle of light beam becomes larger (e.g., from −5 degrees to −90 degrees), the distance that the light beam travels before it reaches the road surface decreases. Thus, the light beam transmitted at certain vertical angles (e.g., between −5 degrees to −90 degrees) cannot be, and need not be, used for long range detections, compared to the light beam transmitted between −5 degrees to +5 degrees. While FIG. 10 does not show, light beams transmitted at the vertical angles between +5 degrees to +90 degrees may not be used for far range object detection either because usually these light beams would be transmitted to the sky, which has no or minimum reflection.

With reference back to FIG. 9, light beams transmitted at different vertical angles may be used for detecting objects located within different detection ranges. For example, light beams 932 transmitted in the dense area are directed to detect objects located in a first detection range and light beams 942 transmitted in the sparse area are directed to detect object located in a second detection range. The first detection range can comprise, for example, a distance of 50 meters or more, measured from the depth sensor 900. The second detection range can comprise, for example, a distance of 0-20 meters measured from the depth sensor 900. The vertical angles at which the light beams 932 are transmitted can be, for example, within −5 degrees to +5 degrees. And the vertical angles at which the transmission of light beams 942 are transmitted can be, for example, from −5 degrees to −90 degrees. As described above, and shown in FIG. 9, light beams 932 are used to detect objects (e.g., object 970) that may be located at a far distance (e.g., more than 50 meters) from depth sensor 900. To detect such an object located far away from depth sensor 900, the sensing resolution of depth sensor 900 may need to be high. The resolution refers to the level of detail that depth sensor 900 can capture. For a LiDAR system (or other depth sensors), the resolution may be expressed in terms of the number of points in a point cloud of the number of pixels or spatial units in a unit area. Thus, the higher the number of points or pixels, the higher the resolution of the depth sensor.

When an object (e.g., object 970) is located far away from the depth sensor 900 (e.g., 50 m-200 m or more), depth sensor 900 needs to have a high resolution to detect the object because the object would appear to be very small from the far-distance. Thus, if light beams for detecting such a far-distance object is sparse, the object may not be detected or may have a low-resolution detection, because none or a few of the light beams may hit the object. As a result, there may not be any return light, or there may be very little return light. Accordingly, to detect such a far-distance object, depth sensor 900 needs to transmit light beams having a high beam density. A beam density refers to the number of light beams within a unit vertical angle (e.g., 1 degree) or a unit area/volume. The higher the beam density, the higher the number of light beams within the unit vertical angle or a unit area/volume. In FIG. 9, the beam density in the dense area is larger than the beam density in the sparse area. The absolute values of the beam densities in the dense and sparse area may depend on the detection distances and object sizes. As shown in FIG. 9, light beams 932 have a high beam density and can thus be used to detect objects located at a far detection range (e.g., 50 m or more). In contrast, depth sensor 900 does not need to have a high beam density to detect objects located near it (e.g., object 972) with a good resolution. As shown in FIG. 9, even if the light beams 942 have a lower beam density than light beams 932, they can be used to detect objects located near depth sensor 900 (e.g., located within 0-20 meters). This is because an object located near the depth sensor 900 would appear to be large, and therefore, it can be detected even if the light beams 942 are sparse.

FIGS. 9 and 10 show that for detecting objects located at a far detection range corresponding to the dense area in the vertical angle range, dense light beams should be used; and for detecting objects located at a near detection range corresponding to the sparse area in the vertical angle range, sparse light beams can be used. Thus, depth sensor 900 can be configured to emit light beams unevenly distributed in the vertical field-of-view such that the vertical FOV has a dense area and a sparse area, with the dense area of the vertical FOV having a higher beam density than the sparse area of the vertical FOV. The uneven distribution of light beams along the vertical FOV can optimize the detection ranges and reduce the energy consumption, while still satisfying the detection resolution requirements for objects in different detection ranges. Compared to using the evenly-distributed light beams, a depth sensor configured to provide uneven distribution of light beams improves the overall system efficiency and performance.

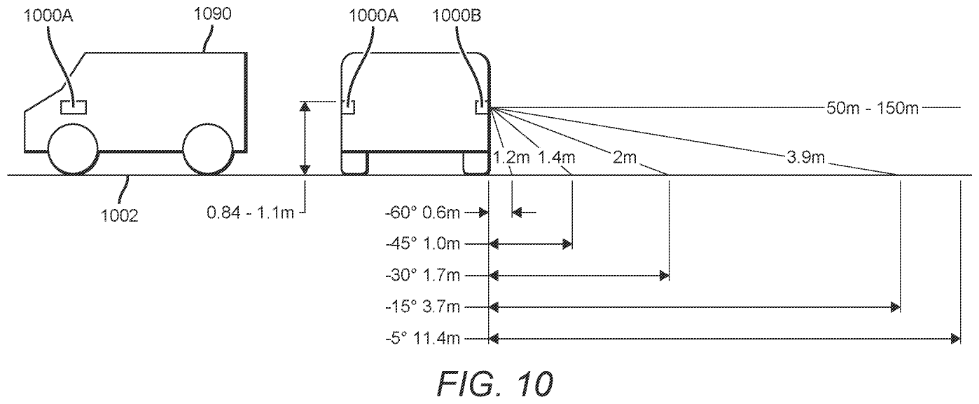

As described above, the light beams provided by a depth sensor (e.g., sensor 800, 900) can be provided directly by one or more light sources or provided by a combination of light source(s) and one or more optical structures. FIG. 11 is a block diagram illustrating an example of providing uneven distribution of light beams by placing VCSEL elements unevenly in a VCSEL laser array 1110, according to some embodiments. As shown in FIG. 11, in this embodiments, optical structures may not be required for providing the uneven distribution of the light beams. The VCSEL laser array 1110 includes a plurality of VCSEL elements 1115A-1115N and 1117A-1117M. These VCSEL elements can form an array (e.g., a 1D or 2D array, arrays, or a matrix). VCSEL elements 1115A-1115N can be arranged closely to each other (e.g., at a predetermined distance for forming a densely-arranged array) such that the light beams 1132 emitted by VCSEL elements 1115A-1115N have a high beam density. The light beams 1132 are thus distributed in a dense area of the vertical FOV. In contrast, the VCSEL elements 1117A-1117M can be arranged sparsely to each other (e.g., at another predetermine distance for forming a sparsely-arranged array). Thus, the light beams 1142 emitted by elements 1117A-1117M are distributed in a sparse area of the vertical FOV. Each of the VCSEL elements 1115A-1115N and 1117A-1117M can also have a predetermined orientation such that it directs a corresponding light beam at a corresponding vertical angle. For instance, element 1117A may be tilted at a certain vertical angle, such that its light beam has a −5 degrees vertical angle in the vertical FOV. Element 1117B may be tilted at another vertical angle, such that its light beam has a −10 degrees vertical angle, and so forth.

In the configuration shown in FIG. 11, by arranging the VCSEL elements 1115A-1115N and 1117A-1117M differently, uneven distribution of the light beams 1132 and 1142 can be obtained, with light beams 1132 having a higher beam density than that of light beams 1142. VCSEL laser array 1110 may not need to have extra optical structures for providing the uneven distribution. In some embodiments, emitting optics 1120 may be coupled to VCSEL laser array 1110 to further shape the light beam, or further assist or fine tune the uneven distribution of the light beams. Such emitting optics 1120 may be, for example, a lens or a lens group. In one example, the emitting optics 1120 can be a collimation lens.

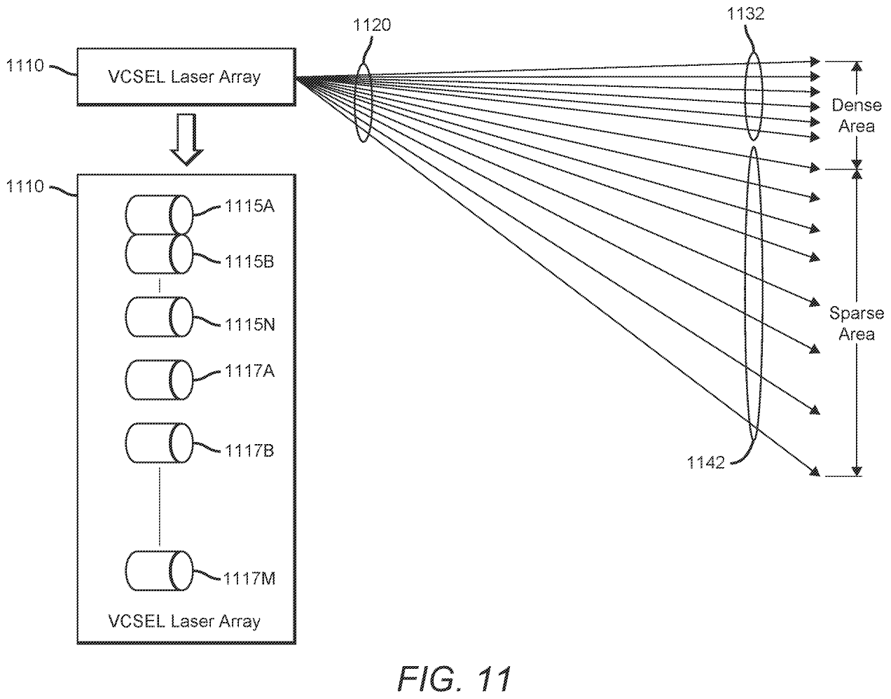

FIG. 11 above illustrates providing the uneven distribution of light beams by an uneven arrangement of the light source elements (e.g., VCSEL elements). FIG. 12 is a block diagram illustrating providing uneven distribution of light beams by using an optical diffuser 1224, according to some embodiments. As shown in FIG. 12, a depth sensor 1200 includes a light source 1220. The light source 1220 has an array of elements (e.g., VCSEL elements) that are evenly distributed. The light beams 1222 emitted by these elements of light source 1220 are thus also evenly distributed. An optical diffuser 1224 forms an optical structure that can be used to create the uneven distribution of the light beams 1222, thereby forming the unevenly distributed light beams 1226. An optical diffuser 1224 can be a device or element used to scatter or diffuse light. Its primary purpose is to create an uneven distribution of light by breaking up at least a portion of incident light beams 1222 into a broader and less intense illumination pattern. As shown in FIG. 12, optical diffuser 1222 can change the direction of some beams more than other beams, and/or re-shape some of the beams, to create an uneven distribution of the light beams. It can diffuse light by scrambling the optical wavefronts and reducing its spatial coherence. Thus, optical diffuser can obtain changes of optical phases for different parts of the profile of the incident light beams. Optical diffuser 1224 can be made from various materials, including glass, plastic, and film. They can be customized with specific patterns or textures that scatter incoming light. These patterns can vary in complexity, ranging from simple rough surfaces to more sophisticated microstructure designs. Optical diffuser 1224 can thus comprise surfaces having micro-optical structures configured to receive evenly distributed light beams and form an uneven distribution of the light beams. The formation of the uneven distribution of light beams can be precisely controlled (by using the micro-optical patterns). Optical diffuser 1224 can therefore achieve specific lighting effects and improve the quality of illumination for a depth sensor. The choice of the diffuser type and design depends on the specific requirements of the depth sensor, including the desired level of diffusion and the intended lighting effect.

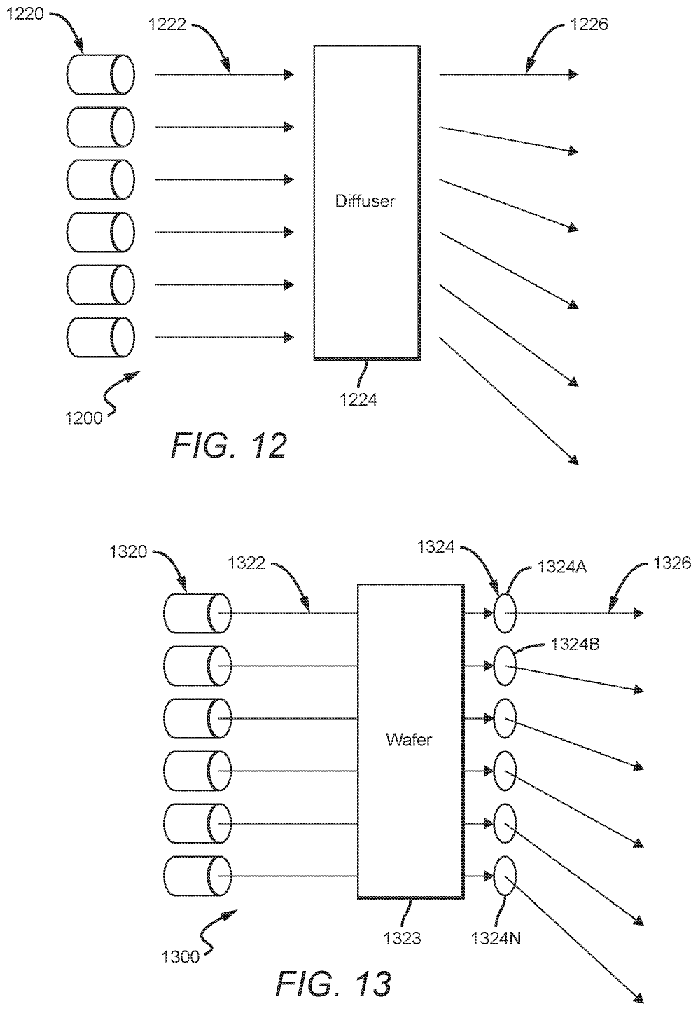

FIG. 13 is a block diagram illustrating providing uneven distribution of light beams by using a semiconductor wafer 1323 having a micro-lens array 1324, according to some embodiments. Like the configuration in FIG. 12, the depth sensor 1300 shown in FIG. 13 includes a light source 1320 that has an array of elements (e.g., VCSEL elements) that are evenly distributed. The light beams 1322 emitted by these elements of light source 1320 are thus also evenly distributed. The depth sensor 1300 shown in FIG. 13 also includes a semiconductor wafer 1323 having a micro-lens array 1324. The micro-lens array 1324 is configured to unevenly distribute the plurality of light beams 1322 in the vertical FOV, thereby forming the unevenly distributed beams 1326.

Semiconductor wafer 1323, also simply referred to as wafer 1323, is a thin, flat, and typically circular slice of semiconductor material, such as silicon, which serves as the substrate for the fabrication of electrical and/or optical devices like a micro-lens array. Wafer 1323 can be silicon based (e.g., silicon, silicon carbide) or based on other semiconductor materials (e.g., gallium nitride based). The semiconductor wafer 1323 is transparent to the light beams 1322 at a certain wavelength or wavelength range, such that light beams 1322 can pass through wafer 1323 and enter micro-lens array 1324. In other words, the light beams 1322 can enter from the back side of wafer 1323 and come out from the front side through the micro-lens array 1324. This configuration is also referred to as the back-illuminated technology. For example, a silicon based wafer is transparent for light beams having a wavelength of 905 nm. In some embodiments, the elements of light source 1320 (e.g., VCSEL elements) may also be disposed on one surface (e.g., the back surface) of wafer 1323; and micro-lens array 1324 can be disposed on the other surface (e.g., the front surface) of wafer 1323. As such, the depth sensor 1300 is highly integrated and can be very compact. In other embodiments, the elements of the light source 1320 can be separate and distinct from wafer 1323.

Micro-lenses in array 1324 are miniature lenses with a very small size, typically on the order of micrometers (μm) or even smaller. Micro-lenses can thus be much smaller than traditional lenses, and therefore, they can be disposed easily into a semiconductor wafer, making the entire sensor very compact. Micro-lenses in array 1324 can be made from various materials, including glass, polymers, or semiconductor materials. The choice of material depends on the type of wafer 1323 and specific optical requirements. As shown in FIG. 13, micro-lenses in array 1324 can shape and redirect light beams 1322. When a beam passes a particular micro-lens in array 1324, the light beam may or may not change its direction. For instance, when the topmost light beam 1322 passes through micro-lens 1324A, the beam may maintain its direction. When other beams pass through their respective micro-lens 1324B-1324N, their directions can be changed to form a group of beams in a dense area of a vertical FOV and another group of beams in a sparse area of the vertical FOV. Thus, in one embodiment, each different micro-lens may be configured differently to bend the respective incident light beam to its intended directions (or corresponding vertical angles). In FIG. 13, for instance, the micro-lens 1324B is designed to bend the light beam slightly downward, so the output beam from micro-lens 1324B is directed at, for example, a −5 degrees vertical angle. In contrast, the micro-lens 1324N is designed to bend the light beam significantly downward, such that the output beam from micro-lens 1324N is directed at, for example, a −45 degree vertical angle.

While FIG. 13 illustrates that each of micro-lenses 1324A-1324N is configured to distribute one of the light beams 1322, it is understood that in other embodiments, a subset of micro-lenses of the array 1324 can be configured to distribute one light beam. For instance, a group of two, three, four, or more micro-lenses 1324 can be arranged together to receive one light beam 1322 and redistribute the light beam to provide one output light beam 1326. Multiple micro-lenses can form a sub-array (1D or 2D) or a sub-group that is placed at the proper location such that an incident light beam can be received by the sub-array or sub-group of micro-lenses.

Micro-lenses array 1324 can be manufactured on a semiconductor wafer 1323 via various semiconductor processing technologies. In one example, the surface of a semiconductor wafer 1323 can be processed to form the micro-lens array 1324 by removing materials from the surface to form the micro-lenses. Removing materials (e.g., silicon, oxide, metal, etc.) from wafer 1323 can be performed via photolithography (e.g., for patterning), chemical etching (e.g., dry etching or wet etching), and/or precision machining (e.g., chemical-mechanical polishing). In another example, the surface of the semiconductor wafer 1323 is processed to form the micro-lens array 1324 by depositing materials to the surface to form the micro-lenses. The materials deposited may comprise, for example, polymer materials, silicon materials, glass materials, plastic materials, etc. Deposition technologies can include physical vapor deposition (PVD), chemical vapor deposition (CVD), atomic layer deposition (ALD), electrochemical deposition, spin coating, sputtering, chemical solution deposition, etc. As one example, tiny droplets of polymer can be deposited to the surface of wafer 1323 to form the micro-lenses with subsequent thermal processes.

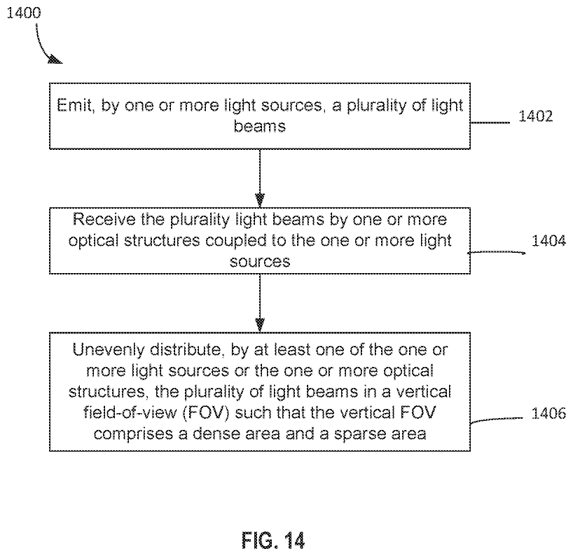

FIG. 14 illustrates a method 1400 for unevenly distributing a plurality of light beams using a depth sensor, according to some embodiments. The depth sensor comprises no mechanically movable parts for scanning the light beams. The method 1400 comprises a step 1402, in which one or more light sources emit a plurality of light beams. In step 1404, the plurality light beams are received by one or more optical structures coupled to the one or more light sources. In step 1406, at least one of the one or more light sources or the one or more optical structures unevenly distributes the plurality of light beams in a vertical field-of-view (FOV) such that the vertical FOV comprises a dense area and a sparse area. The dense area of the vertical FOV has a higher beam density than the sparse area of the vertical FOV. In some embodiments, when the light beams are unevenly distributed, light beams in the dense area of the vertical FOV are directed to detect objects located in a first detection range, and light beams in the sparse area of the vertical FOV are directed to detect objects located in a second detection range. The first detection range is greater than the second detection range. In some examples, the first detection range comprises a distance of 50 meters or more from the depth sensor, and the second detection range comprises a distance of 0-20 meters from the depth sensor. In some examples, the dense area of the vertical FOV corresponds to a vertical angle range of −5 degrees to 0 degrees, or −5 degrees to +5 degrees; and the sparse area of the vertical FOV corresponds to a vertical angle range of at least one of −90 degrees to −5 degrees, or +5 degrees to +90 degrees.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A depth sensor comprising:
one or more light sources configured to provide a plurality of light beams;
one or more optical structures coupled to the one or more light sources, the one or more optical structures being configured to receive the plurality of light beams, wherein:
at least one of the one or more light sources or the one or more optical structures are configured to unevenly distribute the plurality of light beams in a vertical field-of-view (FOV) such that the vertical FOV comprises a dense area and a sparse area, and
the dense area of the vertical FOV has a higher beam density than the sparse area of the vertical FOV, and
wherein the depth sensor comprises no mechanically movable parts configured to scan light.

2. The depth sensor of claim 1, wherein the depth sensor comprises a solid state light ranging and detection (LiDAR) device configured to perform electronic scanning.

3. The depth sensor of claim 1, wherein the depth sensor comprises at least one of a flash LiDAR device or indirect time of flight (iToF) sensor.

4. The depth sensor of claim 1, wherein the one or more light sources comprise one or more of a semiconductor-based laser source, a fiber-based laser source, a liquid-based laser source, a solid-state based laser source, and a gas based laser source.

5. The depth sensor of claim 1, wherein:
light beams in the dense area of the vertical FOV are directed to detect objects located in a first detection range,
light beams in the sparse area of the vertical FOV are directed to detect objects located in a second detection range, the first detection range being greater than the second detection range.

6. The depth sensor of claim 5, wherein the first detection range comprises a distance of 50 meters or more from the depth sensor, and wherein the second detection range comprises a distance of 0-20 meters from the depth sensor.

7. The depth sensor of claim 1, wherein:
the dense area of the vertical FOV corresponds to a vertical angle range of −5 degrees to 0 degrees, or −5 degrees to +5 degrees; and
the sparse area of the vertical FOV corresponds to a vertical angle range of at least one of −90 degrees to −5 degrees, or +5 degrees to +90 degrees.

8. The depth sensor of claim 1, wherein:
the one or more light sources comprise a vertical cavity surface emitting laser (VCSEL) array having an array of VCSEL elements,
the VCSEL elements are configured to be unevenly distributed such that corresponding light beams of the plurality of light beams are unevenly distributed in the vertical FOV.

9. The depth sensor of claim 1, wherein:
the one or more optical structures comprise one or more optical diffusers configured to unevenly distribute the plurality of light beams in the vertical FOV.

10. The depth sensor of claim 9, wherein:
the plurality of light beams comprises evenly distributed light beams before the one or more optical diffusers, and
the one or more optical diffusers comprise surfaces having micro-optical structures configured to receive the evenly distributed light beams and form an uneven distribution of the light beams.

11. The depth sensor of claim 1, wherein the one or more optical structures comprise a semiconductor wafer having a micro-lens array configured to unevenly distribute the plurality of light beams in the vertical FOV.

12. The depth sensor of claim 11, wherein the semiconductor wafer is a silicon based wafer.

13. The depth sensor of claim 11, wherein a subset of micro-lenses of the micro-lens array is configured to distribute one of the plurality of light beams.

14. The depth sensor of claim 11, wherein a surface of the semiconductor wafer is processed to form the micro-lens array by removing materials from the surface to form the micro-lenses.

15. The depth sensor of claim 11, wherein a surface of the semiconductor wafer is processed to form the micro-lens array by depositing materials to the surface to form the micro-lenses.

16. The depth sensor of claim 15, wherein the materials deposited to the surface comprise a polymer material.

17. A method for unevenly distribute light beams using a depth sensor comprising no mechanically movable parts for scanning the light beams, the method comprising:
emitting, by one or more light sources, a plurality of light beams;
receiving the plurality light beams by one or more optical structures coupled to the one or more light sources; and
unevenly distributing, by at least one of the one or more light sources or the one or more optical structures, the plurality of light beams in a vertical field-of-view (FOV) such that the vertical FOV comprises a dense area and a sparse area, wherein the dense area of the vertical FOV has a higher beam density than the sparse area of the vertical FOV.

18. The method of claim 17, wherein unevenly distributing the plurality of light beams comprises:
directing light beams in the dense area of the vertical FOV to detect objects located in a first detection range; and
directing light beams in the sparse area of the vertical FOV to detect objects located in a second detection range, the first detection range being greater than the second detection range.

19. The method of claim 18, wherein the first detection range comprises a distance of 50 meters or more from the depth sensor, and wherein the second detection range comprises a distance of 0-20 meters from the depth sensor.

20. The method of claim 17, wherein:
the dense area of the vertical FOV corresponds to a vertical angle range of −5 degrees to 0 degrees, or −5 degrees to +5 degrees; and
the sparse area of the vertical FOV corresponds to a vertical angle range of at least one of −90 degrees to −5 degrees, or +5 degrees to +90 degrees.

21. A light detection and ranging (LiDAR) system comprising a depth sensor, the depth sensor comprising:
one or more light sources configured to provide a plurality of light beams;
one or more optical structures coupled to the one or more light sources, the one or more optical structures being configured to receive the plurality of light beams, wherein:
at least one of the one or more light sources or the one or more optical structures are configured to unevenly distribute the plurality of light beams in a vertical field-of-view (FOV) such that the vertical FOV comprises a dense area and a sparse area, and
the dense area of the vertical FOV has a higher beam density than the sparse area of the vertical FOV, and
wherein the depth sensor comprises no mechanically movable parts configured to scan light.

22. A vehicle comprising a light detection and ranging (LiDAR) system having a depth sensor, the depth sensor comprising:
one or more light sources configured to provide a plurality of light beams;
one or more optical structures coupled to the one or more light sources, the one or more optical structures being configured to receive the plurality of light beams, wherein:
at least one of the one or more light sources or the one or more optical structures are configured to unevenly distribute the plurality of light beams in a vertical field-of-view (FOV) such that the vertical FOV comprises a dense area and a sparse area, and
the dense area of the vertical FOV has a higher beam density than the sparse area of the vertical FOV, and
wherein the depth sensor comprises no mechanically movable parts configured to scan light.
